(19) United States
(12) Patent Application Publication
(10) Pub. No.: US 2014/0278233 A1
(43) Pub. Date: Sep. 18, 2014

(54) CALCULATION METHOD, COMPUTER PRODUCT, CALCULATING APPARATUS

(71) Applicant: FUJITSU LIMITED, Kawasaki-shi (JP)

(72) Inventor: Jun Maeda, Chofu (JP)

(73) Assignee: FUJITSU LIMITED, Kawasaki-shi (JP)

(21) Appl. No.: 14/291,968

(22) Filed: May 30, 2014

Related U.S. Application Data
(63) Continuation of application No. PCT/JP2011/079107, filed on Dec. 15, 2011.

(51) Int. Cl. G07C 1/10

(52) U.S. Cl. CPC G07C 1/10
USPC 702/176

(57) ABSTRACT

A calculation method includes obtaining a temporal sequence of position data representing movement loci of an agricultural machine; extracting from among the obtained sequence of position data, a set of position data representing an interval among the movement loci of the agricultural machine and in which slopes of segments connecting two points represented by consecutive position data among the sequence of position data are consecutively within a given range; and calculating based on the extracted set of position data representing the interval, a length of a work interval of agricultural work performed by the agricultural machine. The calculation method is executed by a computer.

### CROSS REFERENCE TO RELATED APPLICATIONS

This application is a continuation application of International Application PCT/JP2011/079107, filed on Dec. 15, 2011 and designating the U.S., the entire contents of which are incorporated herein by reference.

### FIELD

The embodiments discussed herein are related to a calculation method, a computer product, and a calculating apparatus.

### BACKGROUND

In agriculture, estimating the yield of a crop planted in a field is important in forecasting crop sales. Further, for farm managers to calculate compensation for workers, knowing the amount of work performed by a worker is desirable.

The cropping area of a crop planted in a field, for example, is a factor used in estimating crop yield and the amount of work performed by a worker. For example, a farm manager can determine crop yield from the cropping area and a standard yield per unit area for the crop. The farm manager can further determine the amount of work performed per day by a worker from the cropping area for 1 day, for example.

A related technology, for example, eliminates uneven growth of grain culm, simplifies water management as well as prevents disease and pest damage or cold weather damage. A further technology is for making selection of proper agricultural machinery such as tractors, rice transplanters, etc. commensurate with land utilization plans and cropping plans easier. For examples, refer to Japanese Laid-Open Patent Publication Nos. 2000-354416 and 2009-169679.

Nonetheless, with the conventional technologies, a problem arises in that determining the cropping area of a crop planted in a field is difficult. For example, in some cases, pathways for control work are provided in a field. In such cases, simply regarding the area of the entire field as the cropping area invites drops in the accuracy of estimation of the cropping area, where the area of the entire field and the cropping area do not coincide. Further, having a worker to go to the site and actually measure the cropping area for a crop that is to be planted in the field invites increases in the work time and workload imposed on the worker.

### SUMMARY

According to an aspect of an embodiment, a calculation method includes obtaining a temporal sequence of position data representing movement loci of an agricultural machine; extracting from among the obtained sequence of position data, a set of position data representing an interval among the movement loci of the agricultural machine and in which slopes of segments connecting two points represented by consecutive position data among the sequence of position data are consecutively within a given range; and calculating based on the extracted set of position data representing the interval, a length of a work interval of agricultural work performed by the agricultural machine. The calculation method is executed by a computer.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1, 2, and 3 are diagrams depicting an example of a calculation method according to a first embodiment;

FIG. 4 is a diagram depicting a system configuration example of a system 400;

FIG. 5 is a block diagram of a hardware configuration of a work area calculating apparatus 401;

FIG. 6 is a block diagram of a hardware configuration of a position measuring apparatus 102;

FIG. 7 is a diagram depicting an example of movement loci data;

FIG. 8 is a diagram depicting an example of the contents of an effective width table 800;

FIG. 9 is a block diagram of an example of a functional configuration of the work area calculating apparatus 401;

FIG. 10 is a diagram depicting an example of an extraction process of extracting a set of position data representing an interval S;

FIG. 11 is a diagram depicting an example of the contents of an interval table 1100;

FIG. 12 is a diagram depicting an example of a calculation process for a travel angle Ai of an agricultural machine M;

FIG. 13 is a diagram depicting an example of a process for calculating a length k of the interval S;

FIG. 14 is a diagram depicting an example of deleting position data representing a terminal point of the interval S;

FIG. 15 is a diagram depicting a detailed example of a work report;

FIGS. 16 and 17 are flowcharts of a procedure of a work area calculation process by the work area calculating apparatus 401;

FIG. 18 is a flowchart depicting a procedure of a work interval length calculation process by the work area calculating apparatus 401;

FIG. 19 is a block diagram of a functional configuration of an obtaining unit 901 of the work area calculating apparatus 401;

FIG. 20 is a diagram depicting an example of deletion of position data for which it can be determined that the agricultural machine M has stopped;

FIG. 21 is a diagram depicting an example of deletion of position data representing points outside a region of a given field;

FIG. 22 is a diagram depicting an example of a separation point of a sequence of position data;

FIG. 23 is a diagram depicting an example of separating a sequence of position data;

FIG. 24 is a diagram depicting an example of deletion of position data that represent an overlapping portion among the movement loci of the agricultural machine M;

FIG. 25 is a flowchart of the first deletion process by the work area calculating apparatus 401;

FIG. 26 is a flowchart depicting a procedure of a second deletion process by the work area calculating apparatus 401; and

FIG. 27 is a flowchart depicting a procedure of a third deletion process by the work area calculating apparatus 401.

### DESCRIPTION OF EMBODIMENTS

Embodiments of a calculation method, a computer product, and a calculating apparatus will be described in detail with reference to the accompanying drawings.

FIGS. 1, 2, and 3 are diagrams depicting an example of a calculation method according to a first embodiment. In FIGS. 1 to 3, a calculating apparatus 101 is a computer configured to calculate the distance of an interval of agricultural work performed by an agricultural machine M. Here, the agricultural machine M is agricultural machinery used in agricultural work. The agricultural machine M has propulsion apparatus such as wheels or continuous tracks, for example. Tractors, cultivators, rice transplanters, combines, pesticide applicators, etc. may be given as examples of the agricultural machine M.

The agricultural machine M is equipped with a position measuring apparatus 102 for measuring the position of the agricultural machine M. The position measuring apparatus 102 measures the position thereof at constant time intervals such as every few seconds, every several 10-seconds, every few minutes, etc., for example. The position measuring apparatus 102 may be held by the worker operating the agricultural machine M.

Agricultural work is work for cultivating and growing crops. Agricultural work is performed by operation of the agricultural machine M by a worker, for example. Plowing, tilling, rice transplanting, seed sowing, fertilizer application, soil preparation, pesticide application, weeding, harvesting, etc. may be given as examples of agricultural work. Further, a crop is, for example, an agricultural crop such as a grain or vegetable cultivated in a field. A field is farmland, cropland, etc. for cultivating and growing crops.

Here, the work area of the agricultural work performed by the agricultural machine M is an index for determining crop yield, the amount of agricultural work, etc. The work area of the agricultural work by the agricultural machine M, for example, can be obtained by multiplying the effective width of the agricultural machine M by the length of the work interval of the agricultural machine M. The work interval of the agricultural machine M is the interval traveled by the agricultural machine M while performing agricultural work, among movement loci of the agricultural machine M.

The effective width of the agricultural machine M is the width of the agricultural work that the agricultural machine M can perform. For example, the effective width of a tractor is the width of the attachment for plowing, tilling, etc. The effective width of a rice transplanter is, for example, the interval between the end shanks of planting shanks disposed along the width of the rice transplanter. Further, the effective width of a combine is, for example, the width of a reaper unit for cutting rice and wheat.

In other words, if the length of the work interval of the agricultural machine M in a field is known, the work area of the agricultural work performed by the agricultural machine M in the field can be obtained. However, the movement loci of the agricultural machine M include, for example, intervals in which no agricultural work is performed by the agricultural machine M, such as intervals in which the agricultural machine M is simply moving in the field and intervals in which the agricultural machine M is moving to change directions.

In this regard, in the first embodiment, a calculation method will be described that extracts from among the movement loci of the agricultural machine M, the intervals of the agricultural work actually performed using the agricultural machine M and calculates the length of the work interval of the agricultural machine M. First to third calculation methods according to the first embodiment will be described with reference to FIGS. 1 to 3.

The first calculation method according to the first embodiment will be described with reference to FIG. 1. In FIG. 1, in an orthogonal coordinate system formed by an x axis and a y axis, points P1 to P31 are depicted that represent movement loci 100 of the agricultural machine M in a given field subject to agricultural work. Here, the points P1 to P31 represent the movement loci 100 of the agricultural machine M in a case where a worker uses the agricultural machine M, which is a tractor, to perform agricultural work such as plowing, tilling, etc.

In a field, ridges are often arranged in the same direction and agricultural work performed by the agricultural machine M is often performed along the ridges. Furthermore, the direction of the ridges is often determined corresponding to the field. Ridges are places where soil of the field is piled up into long, thin, striated linear shapes to plant crops and sow seeds. Therefore, when agricultural work is performed using the agricultural machine M, the travel direction in which the agricultural machine M moves is often a substantially constant direction along the ridges.

Therefore, the calculating apparatus 101 extracts from among the movement loci of the agricultural machine M in the given field, intervals in which the slopes of segments that connect two temporally consecutive points are consecutively within a given range, i.e., intervals in which the travel direction of the agricultural machine M is a substantially constant direction along a ridge and calculates the length of the work interval of the agricultural machine M. Hereinafter, a detailed process procedure of the calculating apparatus 101, according to the first calculation method will be described.

(1-1) The calculating apparatus 101 obtains a sequence of position data that are in temporal order and represent the movement loci of the agricultural machine M. Here, position data is information that indicates the position of the agricultural machine M and, for example, is coordinate information indicating the position of the agricultural machine M in an orthogonal coordinate system formed by an x axis and a y axis. Further, position data includes information specifying time points when the position of the agricultural machine M is measured.

In the example depicted in FIG. 1, the points P1 to P31 represent the movement loci 100 of the agricultural machine M. Further, position data indicating the points P1 to P31 are, for example, measurements by the position measuring apparatus 102 equipped on the agricultural machine M. Thus, the calculating apparatus 101, for example, obtains from the position measuring apparatus 102, a sequence of position data indicating the points P1 to P31 that are in temporal order.

(1-2) The calculating apparatus 101 calculates the slope of each segment that connects two points represented by consecutive position data among the obtained sequence of position data. Here, two points represented by consecutive position data are, for example, the points P1 and P2 that are consecutive temporally. Further, the slope of the segment connecting the points P1 and P2 can be calculated from the coordinate information of the points P1 P2.

(1-3) Based on the slopes calculated for each segment, the calculating apparatus 101 extracts from among the sequence of position data, a set of position data representing intervals among the movement loci of the agricultural machine M and in which the slopes of segments are consecutively within a range SR. Here, the range SR is set to be a range enabling determination that the agricultural machine M is moving in a substantially constant direction along a ridge, when the slopes of the consecutive segments are within the range SR.

In the example depicted in FIG. 1, the slopes of segments that are within intervals S1 to S3 among the movement loci 100 of the agricultural machine M and connect two consecutive points, are consecutively within the range SR. Therefore, a set of position data representing the points P2 to P10 within the interval S1 is extracted as a set of position data representing the interval S1. A set of position data representing the points P12 to P20 within the interval S2 is extracted as a set of position data representing the interval S2. Further, a set of position data representing the points P22 to P30 within the interval S3 is extracted as a set of position data representing the interval S3.

(1-4) Based on the extracted sets of position data representing the intervals, the calculating apparatus 101 calculates the length of the work interval of the agricultural machine M. In the example depicted in FIG. 1, the calculating apparatus 101, for example, cumulates the lengths of the segments that are within the interval S1 and connect two consecutive points, to calculate the length of the interval S1. The calculating apparatus 101 cumulates the lengths of the segments that are within the interval S2 and connect two consecutive points, to calculate the length of the interval S2. Further, the calculating apparatus 101 cumulates the lengths of the segments that are within the interval S3 and connect two consecutive points to calculate the length of the interval S3. The calculating apparatus 101 may sum the lengths of the intervals S1 to S3 to thereby, calculate the length of the work interval of the agricultural machine M.

In this manner, according to the first calculation method, the length of the work interval of the agricultural machine M can be calculated based on a set of position data that represent an interval that is among the movement loci of the agricultural machine M in a given field and in which the slopes of segments connecting two temporally consecutive points, are consecutively within the range SR. Consequently, calculation of the length of the work interval of the agricultural machine M can be performed to exclude from among the movement loci of the agricultural machine M in the given field, intervals in which the agricultural machine M does not move along ridges in the given field, i.e., intervals in which the agricultural machine M does not perform agricultural work.

In the example depicted in FIG. 1, in the given field, intervals in which the agricultural machine M is simply moving can be excluded from among the movement loci 100 of the agricultural machine M, as intervals in which the agricultural machine M does not perform agricultural work, such as between the points P1 and P2, and between the points P30 and P31. Further, intervals in which the agricultural machine M is moving to change direction can be excluded from among the movement loci 100 of the agricultural machine M, as intervals in which the agricultural machine M does not perform agricultural work, such as between points P10 to P12, and between points P20 to P22.

A second calculation method according to the first embodiment will be described with reference to FIG. 2. In FIG. 2, similar to FIG. 1, the points P1 to P31 are depicted that represent in an orthogonal coordinate system formed by an x axis and a y axis, the movement loci of the agricultural machine M in the given field.

As described, in a field, ridges are often arranged in the same direction and agricultural work performed by the agricultural machine M is often performed along the ridges. Furthermore, the lengths of the ridges are often of a certain length or more. Therefore, when agricultural work is performed using the agricultural machine M, often the agricultural machine M continuously moves in substantially the same direction for a given distance or more.

Therefore, the calculating apparatus 101 extracts from among the movement loci of the agricultural machine M in the given field, intervals in which the deviation of the slope of a segment that connects two temporally consecutive points is less than or equal to a threshold for consecutive segments and in which the sum of the lengths of the segments is greater than or equal to a given value, to calculate the length of the work interval of the agricultural machine M. Hereinafter, a detailed process procedure of the calculating apparatus 101, according to the second calculation method will be described.

(2-1) The calculating apparatus 101 obtains a sequence of position data that are in temporal order and represent the movement loci of the agricultural machine M. In the example depicted in FIG. 2, the calculating apparatus 101, for example, obtains from the position measuring apparatus 102, a sequence of position data indicating the points P1 to P31 measured by the position measuring apparatus 102.

(2-2) The calculating apparatus 101 calculates the slope of each segment that connects two points represented by consecutive position data among the obtained sequence of position data.

(2-3) Based on the slope calculated for each segment, the calculating apparatus 101 identifies among the movement loci of the agricultural machine M, intervals in which the deviation of the slope of a segment that connects two points represented by consecutive position data in the sequence of position data is less than or equal to a threshold α for consecutive segments. Here, consecutive segments are, for example, the segment connecting the points P1 and P2, and the segment connecting the points P2 and P3.

The threshold α is set to a value enabling determination that the agricultural machine M is moving in a substantially constant direction, when the deviations of the slopes of consecutive segments that respectively connect two temporally consecutive points among the movement loci of the agricultural machine M are less than or equal to the threshold α. In other words, the calculating apparatus 101 identifies from among the movement loci of the agricultural machine M, intervals in which the agricultural machine M continuously moves in a substantially constant direction.

In the example depicted in FIG. 2, the deviations of the slopes of consecutive segments that respectively connect two consecutive points and are in the intervals S1 to S7 among the movement loci 100 of the agricultural machine M, are less than or equal to the threshold α. Consequently, the intervals S1 to S7 in which the deviations of the slopes of consecutive segments are less than or equal to the threshold α are identified. An interval may be extracted in which a single segment is in the interval, as with the intervals S1 and S7.

(2-4) The calculating apparatus 101 extracts from among the sequence of position data, a set of position data representing an interval in which the cumulative length of the segments within an interval among the identified intervals is greater than or equal to a threshold β. Here, the threshold β is set to a value enabling determination that the agricultural machine M is moving in a substantially constant direction along a ridge, when the cumulative length of the segments within an interval in which the deviations of the slopes of consecutive segments are less than or equal to the threshold α, is greater than or equal to the threshold β.

In the example depicted in FIG. 2, the intervals S2, S4, and S6 are intervals for which the cumulative length of the segments in the interval is greater than or equal to the threshold β. Therefore, sets of position data representing the intervals S2, S4, and S6 are respectively extracted. Thus, sets of position data can be extracted that represent intervals that are among the movement loci of the agricultural machine M and in which the agricultural machine M continuously moves in a substantially constant direction for a given distance or more.

(2-5) Based on the extracted position data representing intervals, the calculating apparatus 101 calculates the lengths of the work interval of the agricultural machine M. In the example depicted in FIG. 2, the calculating apparatus 101, for example, cumulates for each of the intervals S2, S4, and S6, the lengths of the segments that connect two consecutive points, to calculate the length of each of the intervals S2, S4, and S6. The calculating apparatus 101 may sum the lengths of the intervals S2, S4, and S6 to thereby calculate the length of the work interval of the agricultural machine M.

Thus, according to the second calculation method, among the movement loci of the agricultural machine M in the given field, an interval can be identified in which the deviation of the slope of a segment that connects two temporally consecutive points is less than or equal to the threshold α, for consecutive segments. Further, according to the second calculation method, the length of the work interval of the agricultural machine M can be calculated based on a set of position data representing an interval among identified intervals and for which the cumulative length of the segments in the interval is greater than or equal to the threshold β.

In other words, according to the second calculation method, from among the movement loci of the agricultural machine M, intervals in which the agricultural machine M is continuously moving in a substantially constant direction for a given distance or more can be extracted to calculate the length of the work interval of the agricultural machine M. Thus, intervals in which the agricultural machine M does not move along ridges in the given field, i.e., intervals in which the agricultural machine M does not perform agricultural work can be excluded from among the movement loci of the agricultural machine M in the given field to calculate the length of the work interval of the agricultural machine M.

In the example depicted in FIG. 2, intervals in which the agricultural machine M simply moves in the given field can be excluded from among the movement loci 100 of the agricultural machine M, as intervals in which the agricultural machine M does not perform agricultural work, such as between the points P1 and P2, and between the points P30 and P31. Further, intervals in which the agricultural machine M is moving to change direction can be excluded from among the movement loci 100 of the agricultural machine M, as intervals in which the agricultural machine M does not perform agricultural work, such as between the points P10 to P12, and between the points P20 to P22.

A third calculation method according to the first embodiment will be described with reference to FIG. 3. In FIG. 3, similar to FIG. 1, the points P1 to P31 are depicted that represent in an orthogonal coordinate system formed by an x axis and a y axis, the movement loci of the agricultural machine M in the given field.

When the agricultural machine M simple moves in a field, compared to a case where the agricultural machine M moves while performing agricultural work, the speed of the agricultural machine M tends to be slower. Further, the speed of the agricultural machine M when the agricultural machine M moves while performing agricultural work is often a substantially constant speed.

Thus, the calculating apparatus 101 extracts from among the movement loci of the agricultural machine M in a given field, intervals in which the speed of the agricultural machine M moving between two temporally consecutive points is continuously within a given range, to calculate the length of the work interval of the agricultural machine M. Hereinafter, a detailed process procedure of the calculating apparatus 101, according to the third calculation method will be described.

(3-1) The calculating apparatus 101 obtains a sequence of position data that are in temporal order and represent the movement loci of the agricultural machine M. In the example depicted FIG. 3, the calculating apparatus 101, for example, obtains from the position measuring apparatus 102, a sequence of position data indicating the points P1 to P31 measured by the position measuring apparatus 102.

(3-2) The calculating apparatus 101 calculates the speed of the agricultural machine M, for each segment that connects two points represented by consecutive position data among the obtained sequence of position data. For example, for each segment connecting two points, the calculating apparatus 101 calculates the speed of the agricultural machine M by dividing the distance between the two points by the time required for the agricultural machine M to move between the two points.

(3-3) Based on the speeds calculated for each segment, the calculating apparatus 101 identifies among the movement loci of the agricultural machine M, intervals in which the speed of the agricultural machine M moving between two points represented by consecutive position data in the sequence of position data is continuously within a range VR. Here, the range VR is set to a range enabling determination that the agricultural machine M is moving while performing work, when the speed of the agricultural machine M moving between two temporally consecutive points is with within the range VR.

In the example depicted in FIG. 3, among the movement loci 100 of the agricultural machine M, the speed of the agricultural machine M moving between two consecutive points in the interval S1 is continuously within the range VR. Therefore, the interval S1 in which the speed of the agricultural machine M is continuously within the range VR is identified.

(3-4) The calculating apparatus 101 extracts from among the sequence of position data, a set of position data representing the identified interval. In the example depicted in FIG. 3, a set of position data representing the interval S1 is extracted.

(3-5) Based on the extracted set of position data representing the interval, the calculating apparatus 101 calculates the length of the work interval of the agricultural machine M. In the example depicted in FIG. 3, the calculating apparatus 101, for example, may calculate the length of the work interval of the agricultural machine M by cumulating the lengths of the segments that connect two consecutive points in the interval S1.

Thus, according to the third calculation method, the length of the work interval of the agricultural machine M can be calculated based on a set of position data that represent an interval that is among the movement loci of the agricultural machine M in a given field and in which the speed of the agricultural machine M moving between two temporally consecutive points is continuously within the range VR.

Thus, the length of the work interval of the agricultural machine M can be calculated to exclude from among the movement loci of the agricultural machine M in a given field, intervals in which the speed of the agricultural machine M is outside the range VR, i.e., intervals in which the agricultural machine M does not perform agricultural work. In the example depicted in FIG. 3, intervals in which the agricultural machine M simply moves in the given field can be excluded from among the movement loci 100 of the agricultural machine M, as intervals in which the agricultural machine M does not perform agricultural work, such as between the points P1 and P2, and between the points P30 and P31.

A system 400 according to a second embodiment will be described. In the second embodiment, a case will be described where the calculating apparatus 101 according to the first embodiment is applied to a work area calculating apparatus 401 in the system 400. Further, the agricultural machine M corresponds to any one of the agricultural machines, agricultural machines M1 to MF, described hereinafter.

FIG. 4 is a diagram depicting a system configuration example of the system 400. In FIG. 4, the system 400 includes the work area calculating apparatus 401 and the position measuring apparatus 102 in plural (in FIG. 4, 3). In the system 400, the work area calculating apparatus 401 and the position measuring apparatus 102 are connected through a wired or wireless network 410. The network 410 is a local area network (LAN), a wide area network (WAN), etc., for example.

Here, the work area calculating apparatus 401 is a computer that calculates the work area of the agricultural machine M. The work area of the agricultural machine M is the area of agricultural work performed using the agricultural machine M. The work area of the agricultural machine M is, for example, the cropping area, the plowing area, the tilling area, the fertilization application area, the area subject soil preparation, the pesticide application area, weeding area, harvesting area, etc.

The position measuring apparatus 102 is a computer that measures the position of the position measuring apparatus 102. As described, the position measuring apparatus 102 measures the position thereof at constant intervals such as every few seconds, every several 10-seconds, every few minutes, etc., for example. The position measuring apparatus 102 is equipped on the agricultural machines M1 to MF, respectively.

The position measuring apparatus 102 may be held by the workers respectively operating the agricultural machines M1 to MF. For example, the position measuring apparatus 102 may be equipped on a digital camera, a mobile telephone, a personal digital assistant (PDA), a smartphone, and the like carried by the workers.

FIG. 5 is a block diagram of a hardware configuration of the work area calculating apparatus 401. As depicted in FIG. 5, the work area calculating apparatus 401 includes a central processing unit (CPU) 501, read-only memory (ROM) 502, random access memory (RAM) 503, a magnetic disk drive 504, a magnetic disk 505, an optical disk drive 506, an optical disk 507, a display 508, an interface (I/F) 509, a keyboard 510, a mouse 511, a scanner 512, and a printer 513, respectively connected by a bus 500.

The CPU 501 governs overall control of the work area calculating apparatus 401. The ROM 502 stores therein programs such as a boot program. The RAM 503 is used as a work area of the CPU 501. The magnetic disk drive 504, under the control of the CPU 501, controls the reading and writing of data with respect to the magnetic disk 505. The magnetic disk 505 stores therein data written under control of the magnetic disk drive 504.

The optical disk drive 506, under the control of the CPU 501, controls the reading and writing of data with respect to the optical disk 507. The optical disk 507 stores therein data written under control of the optical disk drive 506, the data being read by a computer.

The display 508 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 508.

The I/F 509 is connected to the network 410 through a communication line and is connected to other apparatuses through the network 410. The I/F 509 administers an internal interface with the network 410 and controls the input and output of data with respect to external apparatuses. For example, a modem or a LAN adaptor may be employed as the I/F 509.

The keyboard 510 includes, for example, keys for inputting letters, numerals, and various instructions and performs the input of data. Alternatively, a touch-panel-type input pad or numeric keypad, etc. may be adopted. The mouse 511 is used to move the cursor, select a region, or move and change the size of windows. A track ball or a joy stick may be adopted provided each respectively has a function similar to a pointing device.

The scanner 512 optically reads an image and takes in the image data into the work area calculating apparatus 401. The scanner 512 may have an optical character reader (OCR) function as well. The printer 513 prints image data and text data. The printer 513 may be, for example, a laser printer or an ink jet printer.

The work area calculating apparatus 401 may be configured to omit, for example, the optical disk drive 506, the optical disk 507, the scanner 512, and the printer 513.

FIG. 6 is a block diagram of a hardware configuration of the position measuring apparatus 102. As depicted in FIG. 6, the position measuring apparatus 102 includes a CPU 601, memory 602, an I/F 603, and a global positioning system (GPS) unit 604, respectively connected by a bus 600.

The CPU 601 governs overall control of the position measuring apparatus 102. The memory 602 may include ROM, RAM, and flash ROM. The ROM and flash ROM store various programs such as a boot program, for example. The RAM is used as a work area of the CPU 601.

The I/F 603 is connected to the network 410 through a communication line and is connected to other apparatuses through the network 410. The I/F 603 administers an internal interface with the network 410 and controls the input and output of data with respect to external apparatuses.

The GPS unit 604 receives radio signals from GPS satellites and outputs position data indicating the position of the position measuring apparatus 102. The position data may be, for example, coordinate information identifying one point on a map or coordinate information identifying one point on the planet such as latitude, longitude, etc. The position measuring apparatus 102 may use differential GPS (DGPS) to correct the position data output from the GPS unit 604.

Movement loci data that represent the movement loci of the agricultural machine M measured by the position measuring apparatus 102 will be described. FIG. 7 is a diagram depicting an example of movement loci data. In FIG. 7, movement loci data 700 is information that includes a position data D1 to Dn. The position data D1 to Dn are information indicating agricultural machine IDs, times, and coordinates.

Here, an agricultural machine ID is the identifier of the agricultural machine M. A time is a measurement time at which position data indicating the position of the agricultural machine M was measured. Coordinates are an x coordinate and a y coordinate that identify one point on a map defined by an orthogonal coordinate system formed by an x axis and a y axis. The x axis is defined, for example, in an east-west direction on a map and the y axis is defined, for example, in a north-south direction on the map.

The position data D1 to Dn are sorted chronologically. Taking a position data Di as an example, coordinates (xi, yi) that indicate the position of the agricultural machine M1 at time Ti are indicated. The movement loci data 700 may include, for example, information indicating the names of fields, the names of workers, work details, and the like.

The contents of an effective width table 800 used by the work area calculating apparatus 401 will be described. The effective width table 800, for example, is stored to a storage apparatus such as the ROM 502, the RAM 503, the magnetic disk 505, and the optical disk 507 depicted in FIG. 5.

FIG. 8 is a diagram depicting an example of the contents of the effective width table 800. In FIG. 8, the effective width table 800 has fields for agricultural machine IDs and effective widths, and by setting information into the fields, effective width information 800-1 to 800-F is stored as records. Here, an agricultural machine ID is an identifier of the agricultural machine M. An effective width is the width of the agricultural work that the agricultural machine M can perform. Taking the effective width information 800-1 as one example, an effective width W1 of the agricultural machine M1 is indicated. The effective width W1 is, for example, 1.8[m].

An example of a functional configuration of the work area calculating apparatus 401 according to the second embodiment will be described. FIG. 9 is a block diagram of an example of a functional configuration of the work area calculating apparatus 401. In FIG. 9, the work area calculating apparatus 401 includes an obtaining unit 901, a first calculating unit 902, a second calculating unit 903, an extracting unit 904, a third calculating unit 905, a fourth calculating unit 906, and an output unit 907. The obtaining unit 901 to the output unit 907 are functions forming a control unit and, for example, are implemented by executing on the CPU 501, a program stored in a storage apparatus such as the ROM 502, the RAM 503, the magnetic disk 505, and the optical disk 507 depicted in FIG. 5, or by the I/F 509. Process results of the respective function units are stored to a storage apparatus such as the RAM 503, the magnetic disk 505, and the optical disk 507.

The obtaining unit 901 obtains a sequence of position data that are in temporal order and represent the movement loci of the agricultural machine M. For example, the obtaining unit 901 obtains the movement loci data 700 that represent the movement loci of the agricultural machine M1 by receiving, through the network 410, the movement loci data 700 depicted in FIG. 7, from the position measuring apparatus 102. Further, the obtaining unit 901 may obtain the movement loci data 700 by a user operation of the keyboard 510 or the mouse 511 depicted in FIG. 5.

In the description hereinafter, an obtained sequence of position data may be indicated as “the position data D1 to Dn” and an arbitrary position data among the position data D1 to Dn may be indicated as “position data Di” (i=1, 2, . . . , n). Further, the time at which the position data Di is measured may be indicated as “time Ti”.

The first calculating unit 902 calculates the slope of each segment that connects two points represented by consecutive position data among the position data D1 to Dn. Here, between two points represented by consecutive position data among the position data D1 to Dn is a segment that connects the two points that are temporally consecutive and among the movement loci of the agricultural machine M.

For example, the calculating unit can calculate the slope ai of the segment at time Ti by using Equation (1); where, slope ai is the slope of the segment that connects a point indicated by the position data D(i−1) and a point indicated by the position data Di.

ai=Y/X

X=xi−x(i−1)

Y=yi−y(i−1) (1)

Further, the first calculating unit 902 may calculate a travel angle of the agricultural machine M moving between two points represented by consecutive position data among the position data D1 to Dn. Here, the travel angle of the agricultural machine M is an angle formed by the travel direction of the agricultural machine M and a reference axis, e.g., the angle formed by the travel direction of the agricultural machine M and the x axis. More specifically, for example, the travel angle of the agricultural machine M is the angle from the travel direction of the agricultural machine M moving along a segment connecting two points that are temporally consecutive to the x axis in a counterclockwise direction.

For example, the first calculating unit 902 can calculate the travel angle Ai of the agricultural machine M at the time Ti by using Equation (2). When the value (radians) of the travel angle Ai calculated using Equation (2) is to be converted to degrees, for example, the work area calculating apparatus 401 can perform the conversion by multiplying the value (radians) of the travel angle Ai by “180/π”.

Ai=arctan(Y/X) (2)

Although the first calculating unit 902 has been described to calculate the slope ai and the travel angle Ai, based on consecutive position data among the position data D1 to Dn, configuration is not limited hereto. For example, the first calculating unit 902 may calculate the slope ai and the travel angle Ai, based on non-consecutive position data among the position data D1 to Dn. An example of a calculation process by the first calculating unit 902 and based on non-consecutive position data among the position data D1 to Dn will be described with reference to FIG. 12.

The second calculating unit 903 calculates the speed of the agricultural machine M moving between two points represented by consecutive position data among the position data D1 to Dn. More specifically, for example, the second calculating unit 903 can calculate the speed Vi of the agricultural machine M at time Ti by using Equation (3); where, si is the length of the segment connecting a point indicated by the position data D(i−1) and a point the position data Di.

Vi=si/{Ti−T(i−1)} (3)

The extracting unit 904 extracts from the position data D1 to Dn, a position data group that represents intervals of agricultural work by the agricultural machine M, among the movement loci of the agricultural machine M. More specifically, for example, the extracting unit 904 extracts from among the position data D1 to Dn, a set of position data that represent an interval that is among the movement loci of the agricultural machine M and satisfies at least any one among (condition 1), (condition 2), and (condition 3).

In the description hereinafter, an interval that is among the movement loci of the agricultural machine M and satisfies at least any one among (condition 1), (condition 2), and (condition 3) may be indicated as “interval S”.

(Condition 1) is a condition that identifies an interval S in which the speed Vi of the agricultural machine M at time Ti is continuously within the range VR. Here, the range VR is set to an average speed at which the agricultural machine M moves while performing agricultural work. The range VR may be set for each agricultural machine M, for example.

In the description hereinafter, the range VR may be indicated as “Vl≦Vi≦Vh”. The speed Vl is “3[km/h]”, for example; while Vh is “Vh=6[km/h]”, for example. The range VR may be preliminarily set and stored to a storage apparatus such as the ROM 502, the RAM 503, the magnetic disk 505, and the optical disk 507.

(Condition 2) includes (condition 2-1) and (condition 2-2). (Condition 2-1) is a condition that identifies an interval in which the deviation of the travel angle A(i−1) of the agricultural machine M at time T(i−1) and the deviation of the travel angle Ai of the agricultural machine M at time Ti are consecutively less than or equal to a threshold γ.

The threshold γ is set to a value enabling determination that the agricultural machine M is moving in a substantially constant direction at time T(i−1) and time Ti, when the respective deviations of the travel angle A(i−1) and travel angle Ai are less than or equal to the threshold γ. Specifically, for example, the threshold γ is “γ=15[degrees]”. The threshold γ is preliminarily set and stored in a storage apparatus such as the ROM 502, the RAM 503, the magnetic disk 505, and the optical disk 507, for example.

(Condition 2-2) is a condition that identifies among intervals that satisfy (condition 2-1), an interval S for which the cumulative length of segments in the interval and connecting two temporally consecutive points is greater than or equal to the threshold β. The threshold β is set to a value enabling determination that the agricultural machine M is moving along a ridge, when the cumulative length of the segments in the interval is greater than or equal to the threshold β.

Further, the threshold β may be set for each field, according to the size of the field overall. More specifically, for example, the threshold β is “10[m]”. The threshold β is preliminarily set and stored in a storage apparatus such as the ROM 502, the RAM 503, the magnetic disk 505, and the optical disk 507, for example.

(Condition 3) is a condition that identifies an interval S in which the slopes of segments in the interval and respectively connecting two temporally consecutive points are consecutively within the range SR. Here, the range SR is set to a range enabling determination that the agricultural machine M is moving along a ridge, when the slopes of consecutive segments are within the range SR. The range SR is preliminarily set for each given field and stored in a storage apparatus such as the ROM 502, the RAM 503, the magnetic disk 505, and the optical disk 507, for example. Plural ranges may be set as the range SR.

The range SR may be set based on the slope calculated for each segment, for example. More specifically, for example, the work area calculating apparatus 401 calculates for each range among ranges of a constant width, a rate of sloped segments belonging to the range. The work area calculating apparatus 401 sets the range for which the rate of the sloped segments is greatest, as the range SR. As a result, the range having the highest frequency of sloped segments can be set as the range SR.

According to (condition 1), an interval S in which the agricultural machine M is moving at an average speed at which the agricultural machine M moves while performing agricultural work can be identified from among the movement loci of the agricultural machine M. According to (condition 2), an interval S in which the agricultural machine M is moving in substantially the same direction for a given distance or more can be identified from among the movement loci of the agricultural machine M. According to (condition 3), an interval S in which the travel direction of the agricultural machine M is a substantially constant direction along a ridge in the given field, can be identified from among the movement loci of the agricultural machine M.

The extracting unit 904 may extract from among the position data D1 to Dn, a set of position data representing an interval that is among the movement loci of the agricultural machine M and satisfies more than one condition among (condition 1), (condition 2), and (condition 3). (Condition 2-1) of (condition 2) may be replaced with, for example, a condition that “the deviation of the slope of a segment that connects two temporally consecutive points is less than or equal to the threshold α, for consecutive segments”. An example of an extraction process by the extracting unit 904 will be described with reference to FIG. 10.

The third calculating unit 905 calculates the length of the work interval of the agricultural machine M, based on the extracted set of position data representing an interval S. More specifically, for example, the third calculating unit 905 calculates the lengths of each interval S by cumulating the lengths of the segments therein that connect two consecutive points. The third calculating unit 905 may calculate the length of the work interval of the agricultural machine M by summing the lengths calculated for each interval S.

The third calculating unit 905 may exclude from processing, a set of position data representing an interval S, when among the travel angles of the agricultural machine M moving along a segment that connects two temporally consecutive points in the interval S, the rate of travel angles included in a range AR is less than the threshold δ.

Here, the range AR and the threshold δ are set to values enabling determination that the agricultural machine M is moving along a ridge, when the rate of travel angles included in the range AR is greater than or equal to the threshold δ. The range AR is “40[degrees] or greater and 50[degrees] or less”, for example. The threshold δ is “50[%]”, for example. The range SR and the threshold δ are preliminarily set for each given field and stored in the ROM 502, the RAM 503, the magnetic disk 505, and the optical disk 507, for example. Plural ranges may be set as the range AR.

An example of another calculation process by the third calculating unit 905 will be described with reference to FIGS. 13 and 14.

The fourth calculating unit 906 calculates the work area of the agricultural work performed by the agricultural machine M, based on the calculated length of the work interval of the agricultural machine M and the effective width of the agricultural machine M. More specifically, for example, the fourth calculating unit 906 refers to the effective width table 800 depicted in FIG. 8 and identifies the effective width that corresponds to the agricultural machine ID of the agricultural machine M. The agricultural machine ID of the agricultural machine M can be identified from the movement loci data 700, for example.

The fourth calculating unit 906 can calculate the work area of the agricultural work performed by the agricultural machine M by using Equation (4); where, R is the work area of the agricultural work performed by the agricultural machine M in the given field, K is the length of the work interval of the agricultural machine M in the given field, and W is the effective width of the agricultural machine M.

R=K×W (4)

The output unit 907 outputs the calculated work area R of the agricultural work performed by the agricultural machine M in the given field. Further, the output unit 907 may output the calculated length K of the work interval of the agricultural machine M in the given field. For example, forms of output include display on the display 508, print out by the printer 513, and transmission to an external apparatus through the I/F 509 and may be storage to the RAM 503, the magnetic disk 505, and the optical disk 507.

More specifically, for example, the output unit 907 may output a work report indicating work results for agricultural work performed in a given field. A work report is information indicating, for example, the name of the given field, the name of the worker performing the agricultural work using the agricultural machine M, the work period, work details, and the work area R. Information indicating the name of the given field, the name of the worker, and the work details is included, for example, in the movement loci data 700. A detailed example of a work report will be described with reference to FIG. 15.

An example of an extraction process of extracting a set of position data representing an interval S that is among the movement loci of the agricultural machine M and satisfies (condition 1) and (condition 2) will be described with reference to FIG. 10.

FIG. 10 is a diagram depicting an example of an extraction process of extracting a set of position data representing an interval S. In FIG. 10, in an orthogonal coordinate system formed by an x axis and a y axis, the points P1 to P28 are depicted that represent the movement loci 1000 of the agricultural machine M in a given field. The points P1 to P28 respectively correspond to the position data D1 to D28 in temporal order.

An interval from the point P1 to the point P3 among the movement loci 1000 of the agricultural machine M does not satisfy (condition 1) since the speed of the agricultural machine M is fast and is not within the range VR. Similarly, an interval from the point P27 to the point P28 among the movement loci 1000 of the agricultural machine M does not satisfy (condition 1) since the speed of the agricultural machine M is fast and is not within the range VR.

An interval from the point P9 to the point P11 among the movement loci 1000 of the agricultural machine M does not satisfy (condition 2) since the cumulative length of the segments in the interval is less than the threshold β. Similarly, an interval from the point P18 to the point P20 among the movement loci 1000 of the agricultural machine M does not satisfy (condition 2) since the cumulative length of the segments in the interval is less than the threshold β.

Consequently, in the example depicted in FIG. 10, sets of position data representing the intervals S1 to S3 among the movement loci 1000 of the agricultural machine M are extracted. More specifically, for example, the position data D3 to D9 representing the interval S1, the position data D11 to D18 representing the interval S2, and the position data D20 to D27 representing the interval S3 are extracted. In this case, the third calculating unit 905 calculates the length K of the work interval of the agricultural machine M, based on the extracted sets of position data representing the intervals S1 to S3.

Information related to position data representing each interval S is stored to an interval table 1100 depicted in FIG. 11, for example. The interval table 1100 is implemented by a storage apparatus such the RAM 503, the magnetic disk 505, and the optical disk 507, for example. Here, the contents of the interval table 1100 will be described.

FIG. 11 is a diagram depicting an example of the contents of the interval table 1100. In FIG. 11, the interval table 1100 has fields for interval IDs, position data IDs, and lengths; and by setting information into the fields, interval the information 1100-1 to 1100-3 is stored as records.

Here, an interval ID is an identifier of an interval S. A position data ID is an identifier of a position data. A length is the length of the interval S. Taking interval the information 1100-1 as an example, the position data IDs “D3, D4, D5, D6, D7, D8, and D9” representing the interval S1, and the length “k1” are indicated.

An example of a calculation process by the first calculating unit 902 and based on two non-consecutive position data among the position data D1 to Dn will be described.

Here, the position data measured by the GPS unit 604 of the position measuring apparatus 102 may include measurement error. Therefore, for example, when the extracting unit 904 uses (condition 2) to extract a set of position data representing an interval S, a case may arise where a large number of intervals among the movement loci of the agricultural machine M do not satisfy (condition 2) consequent to measurement error of the position data.

The first calculating unit 902 may calculate the slope ai or the travel angle Ai between two points separated by plural points among the movement loci of the agricultural machine M. As a result, the movement loci of the agricultural machine M are smoothed, affording resistance to the effects of temporary travel direction changes that are consequent to measurement error of the position data.

More specifically, for example, the first calculating unit 902 may calculate the slope ai for each segment that connects two temporally non-consecutive points among the movement loci of the agricultural machine M. Further, the first calculating unit 902 may calculate the travel angle Ai of the agricultural machine M moving between two temporally non-consecutive points among the movement loci of the agricultural machine M. A case where the travel angle Ai of the agricultural machine M is calculated based on two non-consecutive position data among the position data D1 to Dn will be described with reference to FIG. 12.

FIG. 12 is a diagram depicting an example of a calculation process for the travel angle Ai of the agricultural machine M. In FIG. 12, the points P1 to P9 representing temporally sequential movement loci 1200 of the agricultural machine M are depicted.

Here, when the first calculating unit 902 calculates the travel angle Ai of the agricultural machine M moving between temporally consecutive points among the movement loci 1200 of the agricultural machine M, for example, around the point P4, the deviations of the travel angle A3 of the agricultural machine M at time T3 and the travel angle A4 of the agricultural machine M at time T4 are greater than the threshold γ.

In contrast, when the first calculating unit 902 calculates the travel angle Ai of the agricultural machine M moving between two points separated by two points among the movement loci 1200 of the agricultural machine M, for example, the deviations of the travel angle A3′ of the agricultural machine M at time T3 and the travel angle A4′ of the agricultural machine M at time T4 are less than or equal to the threshold γ.

In this manner, by calculating the travel angle Ai of the agricultural machine M moving between two points that are separated by plural points among the movement loci of the agricultural machine M, the movement loci of the agricultural machine M are smoothed, affording resistance to the effects of temporary travel direction changes that are consequent to measurement error of the position data. As a result, for example, around the point P4 along the movement loci 1200 of the agricultural machine M, the interval is cut and the resulting interval, for example, an interval Sa of a short length from point P4 and satisfying (condition 2-1) can be prevented from not being extracted as an interval that satisfies (condition 2).

Another calculation process by the third calculating unit 905 to calculate the length K of the work interval of the agricultural machine M will be described with reference to FIGS. 13 and 14.

As described, position data measured by the GPS unit 604 of the position measuring apparatus 102 may include measurement error. Therefore, for each interval S, when the lengths of segments therein connecting two consecutive points are cumulated to calculate the length of the interval S, consequent to measurement error of the position data, the calculated length may be longer than the actual distance that the agricultural machine M moved, for example.

Thus, configuration may be such that the third calculating unit 905 subjects the loci in the interval S traveled by the agricultural machine M, to parallel linearization to thereby, correct the loci in the interval S according to the actual movement of the agricultural machine M and to approximate the loci that are in the interval S and include measurement error, to the actual loci.

For example, the third calculating unit 905 calculates the average of the slopes of the segments that connect two points represented by consecutive position data among a set of position data representing the interval S. Subsequently, the third calculating unit 905 calculates coordinate information of an intersection of a first line and a second line. Among first and second terminal points of the interval S, the first line passes through the first terminal point and whose slope is the calculated slope. The second line passes through the second terminal point and is orthogonal to the first line.

Based on the coordinate information of the second terminal point and the calculated coordinate information of the intersection, the third calculating unit 905 may calculate the length k of the interval S. A case where the loci in an interval S traveled by the agricultural machine M are subject to parallel linearization to calculate the length k of the interval S will be described with reference to FIG. 13.

FIG. 13 is a diagram depicting an example of a process for calculating the length k of an interval S. In FIG. 13, the points P1 to P6 that represent an interval Sb traveled by the agricultural machine M are depicted. In the example depicted in FIG. 13, the third calculating unit 905 calculates the average G of the slopes of segments that are in interval Sb and connect two temporally consecutive points.

The third calculating unit 905 calculates coordinate information of an intersection z of a first line 1301 and a second line 1302. Here, among the terminal points P1 and P6 of the interval Sb, the first line 1301 is a line that passes through the terminal point P1 and whose slope is the calculated average slope G. The second line 1302 is a line that passes through the terminal point P6 and is orthogonal to the first line 1301. Based on the coordinate information of the terminal point P1 of the interval Sb and the calculated coordinate information of the intersection z, the third calculating unit 905 calculates the length of a segment 1303 that connects the terminal point P1 and the intersection Z, as the length kb of the interval Sb.

Thus, by subjecting the loci of the agricultural machine M in interval Sb to parallel linearization, the movement loci of the agricultural machine M can be corrected according to the actual movement, enabling improved accuracy of the calculation of the length K of the work interval of the agricultural machine M.

The travel angle of for a portion traveled by the agricultural machine M to change directions may satisfy (condition 2-1), when in a given field, the agricultural machine M changes directions to switch from one ridge to an adjacent ridge. Often no agricultural work is performed by the agricultural machine M in the portion traveled to change directions.

Therefore, when the extracting unit 904 uses (condition 2) to extract a set of position data representing the interval S, in the portion traveled by the agricultural machine M to change directions, position data may be extracted for a portion in which no agricultural work is performed by the agricultural machine M. Thus, configuration may be such that the third calculating unit 905 deletes from a set of position data representing the interval S, the position data representing the portion traveled by the agricultural machine M to change directions.

For example, the third calculating unit 905 calculates the average of the slopes of the segments that connect two points represented by consecutive position data that are among the set of position data representing the interval S and exclude the position data of at least one of the terminal points of the interval S. The third calculating unit 905 calculates the slopes of the segments that connect two points represented by consecutive position data that are among the set of position data representing the interval S and include position data representing one of the terminal points.

When the difference of the calculated slope and the calculated average slope is greater than or equal to a threshold η, the third calculating unit 905 deletes from the set of position data representing interval S, the position data representing the terminal end. Here, for example, the threshold η is set to a value enabling determination that at the terminal point of the interval S, the agricultural machine M is moving to change directions, when the deviation of the slope at the terminal point of the interval S and the deviation of the average slope of the interval S are greater than or equal to the threshold 11. The threshold η is preliminarily set and stored in a storage apparatus such as the ROM 502, the RAM 503, the magnetic disk 505, and the optical disk 507, for example.

Thus, position data representing a portion for which it can be determined that the agricultural machine M is moving to change directions can be deleted from among the set of position data representing the interval S. Further configuration may be such that the third calculating unit 905 calculates the length K of the work interval of the agricultural machine M, based on the set of position data representing the interval S from which the position data representing the terminal point has been deleted.

The third calculating unit 905, for example, calculates for each range among ranges of a constant width, the rate of sloped segments belonging to the range, among the slopes of segments that connect two point represented by consecutive position data that remain among set of position data representing the interval S from which the position data of the terminal end has been deleted. Further, the third calculating unit 905 identifies from among the ranges, a range for which the rate is greater than or equal to a constant rate, for example, 50[%].

The third calculating unit 905 determines whether the slope of the segment that connects two points represented by consecutive position data that include the position data representing the terminal point and are among the set of position data representing the interval S, is included in the identified range. Configuration may be such that if the slope is not included in the identified range, the third calculating unit 905 deletes from the set of position data representing the interval S, the position data that represents the terminal point.

As a result, the position data representing a portion whose sloped segments are not included in a range having a high frequency of sloped segments, i.e., a portion for which it can be determined that the agricultural machine M is moving to change directions, can be deleted from among the set of position data representing the interval S. An example of deleting from the set of position data representing the interval S, the position data representing a terminal point of the interval S will be described with reference to FIG. 14.

FIG. 14 is a diagram depicting an example of deleting the position data representing a terminal point of the interval S. In FIG. 14, the points P1 to P8 representing an interval Sc traveled by the agricultural machine M are depicted. In the example depicted in FIG. 14, the third calculating unit 905 calculates the average G of the slopes of segments that connect two consecutive points that are among the points P1 to P8 representing the interval Sc and exclude the terminal point P8 of the interval Sc.

Subsequently, the third calculating unit 905 calculates the slope of a segment that connects two consecutive points that include the terminal point P8 among the points P1 to P8 representing the interval Sc, i.e., the segment that connects the point P7 and the terminal point P8. The third calculating unit 905 determines whether the difference of the slope of the segment connecting the point P7 and the terminal point P8, and the average G is greater than or equal to the threshold η.

In this example, the difference of the slope of the segment connecting the point P7 and the terminal point P8, and the average G is greater than or equal to the threshold η. Therefore, the third calculating unit 905 deletes from the set of position data representing the interval Sc, the position data indicating the terminal point P8. As a result, the position data representing the portion between the points P7 and P8, for which it can be determined that the agricultural machine M is moving to change directions, can be deleted from among the set of position data representing the interval Sc.

Although the third calculating unit 905 has been described to determine whether to delete position data representing a terminal point of an interval S, based on the slopes of segments connecting two temporally consecutive points in the interval S, the third calculating unit 905 may make the determination based on the travel angle of the agricultural machine M moving between the two points.

A detailed example of a work report indicating work results for agricultural work performed in the given field will be described with reference to FIG. 15. FIG. 15 is a diagram depicting a detailed example of a work report. In FIG. 15, a work report 1500 is information indicating work results for agricultural work performed in the given field, by the agricultural machine M.

For example, the work report 1500 indicates “xxx” as the name of a given field; “Taro Fuji” as the name of the working performing agricultural work using the agricultural machine M; “time T1 to time Tn” as the work period; “tilling” as work details; and “R” as the work area. From the work report 1500, for example, the farm manager can estimate for the given field, the crop yield and the amount of agricultural work.

A procedure of a work area calculation process by the work area calculating apparatus 401 will be described. FIGS. 16 and 17 are flowcharts of a procedure of a work area calculation process by the work area calculating apparatus 401. In the flowchart depicted in FIG. 16, the work area calculating apparatus 401 determines whether the position data D1 to Dn, which are in temporal order and represent the movement loci of the agricultural machine M have been obtained (step S1601).

The work area calculating apparatus 401 stands by until the position data D1 to Dn are obtained (step S1601: NO). When the position data D1 to Dn have been obtained (step S1601: YES), the work area calculating apparatus 401 sets “i” of the position data Di to “i=1” (step S1602), and sets “j” of the interval Sj to “j=1” (step S1603).

The work area calculating apparatus 401 records the identifier of the position data Di into the position data ID field of the interval Sj in the interval table 1100 (step S1604). The work area calculating apparatus 401 increments “i” of the position data Di (step S1605), and determines whether “i” exceeds “n” (step S1606).

If “i” is less than or equal to “n” (step S1606: NO), the work area calculating apparatus 401 calculates the speed Vi of the agricultural machine M, based on the position data Di and the position data D(i−1) (step S1607), and determines if the speed Vi of the agricultural machine M is greater than or equal to a speed Vl and less than or equal to a speed Vh (step S1608).

If the speed Vi of the agricultural machine M is not greater than or equal to the speed Vl and less than or equal to the speed Vh (step S1608: NO), the work area calculating apparatus 401 proceeds to step S1611. On the other hand, if the speed Vi of the agricultural machine M is greater than or equal to the speed Vl and less than or equal to the speed Vh (step S1608: YES), the work area calculating apparatus 401 calculates the travel angle Ai of the agricultural machine M, based on the position data Di and the position data D(i−1) (step S1609).

The work area calculating apparatus 401 determines if the deviations of travel angles A(i−1) and Ai of the agricultural machine M are less than or equal to the threshold γ (step S1610). If the deviations of the travel angles A(i−1) and Ai are less than or equal to the threshold γ (step S1610: YES), the work area calculating apparatus 401 returns to step S1604. Further, if the travel angle A(i−1) of the agricultural machine M has not been calculated, the work area calculating apparatus 401 returns to step S1604.

On the other hand, if the deviations of the travel angles A(i−1) and Ai exceed the threshold γ (step S1610: NO), the work area calculating apparatus 401 refers to the interval table 1100 and extracts from the position data D1 to Dn, a set of position data that represent the interval Sj (step S1611).

The work area calculating apparatus 401 calculates the length kj of the interval Sj by cumulating the lengths of the segments that connect two points represented by temporally consecutive position data among the set of position data that represent the interval Sj (step S1612). The work area calculating apparatus 401 determines if the length kj of the interval Sj is greater than or equal to the threshold β (step S1613).

If the length kj of the interval Sj is greater than or equal to the threshold β (step S1613: YES), the work area calculating apparatus 401 registers the length kj of the interval Sj into the length field for the interval Sj in the interval table 1100 (step S1614). The work area calculating apparatus 401 increments “j” of the interval Sj (step S1615), and returns to step S1604.

At step S1613, if the distance kj of the interval Sj is less than the threshold β (step S1613: NO), the work area calculating apparatus 401 deletes the position data identifier registered in the position data ID field for the interval Sj in the interval table 1100 (step S1616), and returns to step S1604.

At step S1606, if “i” exceeds “n” (step S1606: YES), the work area calculating apparatus 401 proceeds to step S1701 depicted in FIG. 17. In the description hereinafter, one or more intervals registered in the interval table 1100 may be indicated as “interval S1 to Sm” (m=natural number of 1 or more).

In the flowchart depicted in FIG. 17, the work area calculating apparatus 401 refers to the interval table 1100 and calculates the length K of the work interval of the agricultural machine M by cumulating the lengths k1 to km of the intervals S1 to Sm (step S1701).

The work area calculating apparatus 401 refers to the effective width table 800 and identifies the effective width W of the agricultural machine M (step S1702). The work area calculating apparatus 401 uses Equation (4) and calculates the work area R of the agricultural work performed by the agricultural machine M, in the given field (step S1703).

The work area calculating apparatus 401 creates a work report indicating work results for the agricultural work performed in the given field, based on the work area R of the agricultural work performed by the agricultural machine M, in the given field (step S1704). The work area calculating apparatus 401 outputs the work report (step S1705), and ends a series of operations according to the flowcharts.

Thus, based on a set of position data that represent an interval S that is among the movement loci of the agricultural machine M and satisfies (condition 1) and (condition 2), the length K of the work interval of the agricultural machine M can be calculated. Further, the work area R of the agricultural work performed by the agricultural machine M, in a given field is calculated, enabling output of a work report that indicates the work results for the agricultural work performed in the given field.

A procedure of a work interval length calculation process by the work area calculating apparatus 401 in a case where the length K of the work interval of the agricultural machine M is calculated by subjecting to parallel linearization, the loci in an interval Sj traveled by the agricultural machine M. The work interval length calculation process is called at step S1701 depicted in FIG. 17, for example.

FIG. 18 is a flowchart depicting a procedure of a work interval length calculation process by the work area calculating apparatus 401. In the flowchart depicted in FIG. 18, the work area calculating apparatus 401 sets “j” of the interval Sj to “j=1” (step S1801), and selects the interval Sj from among the intervals S1 to Sm (step S1802).

The work area calculating apparatus 401 calculates the average slope G of segments that connect two points represented by consecutive position data in the set of position data that represent the interval Sj (step S1803). The work area calculating apparatus 401 calculates the first line, which passes through a first terminal point among first and second terminal points of the interval Sj and whose slope is the average slope G (step S1804).

The work area calculating apparatus 401 calculates the second line, which passes through the second terminal point of the interval Sj and is orthogonal to the first line (step S1805). The work area calculating apparatus 401 calculates coordinate information of an intersection of the first line and the second line (step S1806).

The work area calculating apparatus 401 calculates the distance kj of the interval Sj by calculating the length of the segment that connects the first terminal point of the interval Sj and the intersection of the first line and the second line (step S1807). The work area calculating apparatus 401 increments “j” of the interval Sj (step S1808), and determines whether “j” exceeds “m” (step S1809).

If “j” is less than or equal to “m” (step S1809: NO), the work area calculating apparatus 401 returns to step S1802. On the other hand, if “j” exceeds “m” (step S1809: YES), the work area calculating apparatus 401 calculates the length K of the work interval of the agricultural machine M by cumulating the lengths k1 to km of the intervals S1 to Sm (step S1810), and ends a series of operations according to the flowchart.

Thus, the movement loci of the agricultural machine M can be corrected according to the actual movement, enabling improved accuracy of the calculation of the length K of the work interval of the agricultural machine M.

As described, the work area calculating apparatus 401 according to the second embodiment enables a set of position data that represent an interval that is among the movement loci of the agricultural machine M and satisfies at least any one among (condition 1), (condition 2), and (condition 3) to be extracted from among the position data D1 to Dn.

For example, (condition 1) enables a set of position data to be extracted that represent an interval S in which the speed Vi of the agricultural machine M is continuously within the range VR. As a result, from among the movement loci of the agricultural machine M, an interval S can be identified in which the agricultural machine M is moving at an average speed at which the agricultural machine M moves while performing agricultural work.

For example, (condition 2) enables a set of position data to be extracted that represent an interval S for which the deviations of the travel angles Ai at temporally consecutive times Ti are less than or equal to the threshold γ and for which the cumulative length of the segments that connect two temporally consecutive points is greater than or equal to the threshold β. As a result, an interval S for which it can be determined that the agricultural machine M is moving in substantially the same direction for a given distance or more, i.e., the agricultural machine M is moving along a ridge in a given field, can be identified from among the movement loci of the agricultural machine M.

For example, (condition 3) enables a set of position data to be extracted that represent an interval S in which the slopes of consecutive segments respectively connecting two temporally consecutive points in the interval are within the range SR. As a result, an interval S in which the travel direction of the agricultural machine M is substantially a constant direction, i.e., a direction parallel to ridges formed in the given field, can be identified from among the movement loci of the agricultural machine M.

Further, for example, a set of position data representing an interval S in which the speed Vi of the agricultural machine M is continuously within the range VR and the deviations of the travel angles Ai of the agricultural machine M at temporally consecutive times Ti are less than or equal to the threshold γ and the cumulative length of the segments connecting two temporally consecutive points is greater than or equal to the threshold β can be extracted by combining (condition 1) and (condition 2). As a result, an interval S in which the agricultural machine M is moving in substantially the same direction for a given distance or longer and at an average speed at which the agricultural machine M moves when performing agricultural work, can be identified from among the movement loci of the agricultural machine M.

The work area calculating apparatus 401 enables the travel angle Ai of the agricultural machine M moving along the slope ai of a segment connecting two temporally consecutive points or moving along the segment, to be calculated based on two non-consecutive position data among the position data D1 to Dn. As a result, the movement loci of the agricultural machine M are smoothed, affording resistance to the effects of temporary travel direction changes that are consequent to measurement error of the position data Di.

The work area calculating apparatus 401 enables the length K of the work interval of the agricultural machine M to be calculated by summing the lengths of the intervals S. Further, the work area calculating apparatus 401 enables the work area R of the agricultural work performed by the agricultural machine M to be calculated based on the length K of the work interval of the agricultural machine M and the effective width W of the agricultural machine M. As a result, a work report indicating the name of the given field, the name of the worker performing the agricultural work using the agricultural machine M, the work period, work details, and the work area R can be created, enabling the farm manager to estimate for the given field, the crop yield and the amount of agricultural work, for example.

The work area calculating apparatus 401 enables the distance from the first terminal point of the interval S to the intersection of the first line and the second line to be calculated as the length k of the interval S. The first line is a line that passes through the first terminal point of the interval S and whose slope is the average slope of the segments in the interval S. The second line is a line that passes through the second terminal point of the interval S and is orthogonal to the first line. Thus, the loci of the agricultural machine M in the interval S are subject to parallel linearization, enabling the movement loci of the agricultural machine M to be corrected according to the actual movement and thereby, enabling improved accuracy of the calculation of the length K of the work interval of the agricultural machine M.

The work area calculating apparatus 401 enables position data that represents a portion for which it can be determined that the agricultural machine M is moving to change directions, to be deleted from the set of position data representing the interval S. As a result, a portion traveled by the agricultural machine M to change directions is excluded from among the movement loci of the agricultural machine M, thereby enabling improved accuracy of the calculation of the length K of the work interval of the agricultural machine M.

The work area calculating apparatus 401 according to a third embodiment will be described. In the third embodiment, a case will be described where position data that represent points where the agricultural machine M stops or points outside the given field are deleted from among the position data D1 to Dn that represent the movement loci of the agricultural machine M. Depiction and description of parts identical to those described in the second embodiment will be omitted hereinafter.

An example of a functional configuration of the obtaining unit 901 of the work area calculating apparatus 401 according to the third embodiment will be described. FIG. 19 is a block diagram of a functional configuration of the obtaining unit 901 of the work area calculating apparatus 401. In FIG. 19, the obtaining unit 901 of the work area calculating apparatus 401 includes a deleting unit 1901 and a separating unit 1902.

The deleting unit 1901 deletes from among the position data D1 to Dn, a position data that represents either one of the terminal points of a segment connecting two points represented by consecutive position data among the position data D1 to Dn, when the length of the segment is less than or equal to a threshold τ.

The threshold τ is set to a value enabling determination that the agricultural machine M has stopped consequent to, for example, failure, a break taken by the worker, etc., when the length of the segment is less than or equal to the threshold τ. The threshold τ is “5[m]”, for example. The threshold τ is preliminarily set and stored in a storage apparatus such as the ROM 502, the RAM 503, the magnetic disk 505, and the optical disk 507, for example.

Thus, a position data that represents a point for which it can be determined that the agricultural machine M has stopped consequent to failure, a break taken by the worker, etc. can be deleted from among the position data D1 to Dn that represent the movement loci of the agricultural machine M. An example of the deletion of a position data that represents a point for which it can be determined that the agricultural machine M has stopped will be described with reference to FIG. 20.

When position data representing a terminal point of a segment whose length is less than or equal to the threshold τ, the extracting unit 904 may extract from the position data D1 to Dn after the deletion, a set of position data representing an interval S. As a result, the work interval of the agricultural machine M can be extracted from among the movement loci of the agricultural machine M, excluding the points where the agricultural machine M has stopped consequent to failure of the agricultural machine M, a break taken by the worker, etc.

If any of the position data D1 to Dn has been deleted, the position data IDs of remaining position data are reassigned in temporal order.

The deleting unit 1901 may be configured to delete from among the position data D1 to Dn, position data representing points outside a region of a given field, based on position data identifying the region of the given field. Here, position data identifying a region of a given field is, for example, coordinate information indicating positions of vertices of the region of a given field. Position data identifying the region of a given field given field is obtained, for example, by user operation of the keyboard 510 and/or mouse 511.

Thus, position data representing point outside the region of a given field can be deleted from among the position data D1 to Dn representing the movement loci of the agricultural machine M. An example of deletion of position data representing points outside the region of a given field will be described with reference to FIG. 21.

When position data representing points outside the region of a given field have been deleted, the extracting unit 904 may extract from among the position data D1 to Dn after the deletion, a set of position data representing an interval S. As a result, the work interval of the agricultural machine M can be extracted from among the movement loci of the agricultural machine M, excluding the points outside the region of the given field.

Dead space for the agricultural machine M to turn back may be provided in a field. If this dead space is left unplowed, the cropping area decreases and/or weeds invade, inviting drops in work efficiency and therefore, often agricultural work such as plowing and tilling is also performed with respect to dead space to plant crops. In this case, for example, the loci of the agricultural machine M may overlap in a dead space region in a field.

Hereinafter, a case will be described where position data that represent a portion where loci among the movement loci of the agricultural machine M overlap, are deleted from among the position data D1 to Dn.

The separating unit 1902 separates the position data D1 to Dn into the first position data group and the second position data group. For example, the separating unit 1902 calculates for each range among ranges of a constant width, the rate of travel angles belonging to the range, among the travel angles A2 to An of the agricultural machine M. Here, the ranges are, for example, are a set of ranges cut into 0-degree to 10-degree widths.

The separating unit 1902 identifies the range having the greatest rate among the ranges. The separating unit 1902, for each time Ti at which the position data Di is measured, calculates the rate of travel angles belonging to the range having the greatest rate, among travel angles of the agricultural machine M based on position data measured before time Ti. Based on the rate of travel angles belonging to the range having the greatest rate at each time Ti, the separating unit 1902, determines from among time T1 to Tn, the time Td at which the position data D1 to Dn are to be separated.

Based on the determined time Td, the separating unit 1902 separates the position data D1 to Dn into the first position data group and the second position data group. For example, the time Td is assumed to be “Td=T10”. In this case, the separating unit 1902, for example, the position data D1 to Dn separates into the position data D1 to D9, and the position data D10 to Dn. An example of separating the position data D1 to Dn will be described with reference to FIGS. 22 and 23.

The deleting unit 1901 deletes from among the resulting first position data group, position data that represents a portion where the movement loci of the agricultural machine M represented by the first position data group and the movement loci of the agricultural machine M represented by the second position data group overlap. As a result, position data representing a portion where loci among the movement loci of the agricultural machine M overlap can be deleted from among the position data D1 to Dn. An example of deletion of position data representing a portion where loci among the movement loci of the agricultural machine M overlap will be described with reference to FIG. 24.

In this case, the extracting unit 904 may be configured to extract from the first position data group after the deletion of the position data that represents the overlapping portion, a set of position data representing an interval S and to extract from the second position data group, a set of position data representing an interval S. As a result, the work interval of the agricultural machine M can be extracted from among the movement loci of the agricultural machine M, excluding the overlapping portion.

FIG. 20 is a diagram depicting an example of deletion of position data for which it can be determined that the agricultural machine M has stopped. In FIG. 20, the points P1 to point P11 that represent movement loci 2000 through which the agricultural machine M moves are indicated. In the example depicted in FIG. 20, among segments s1 to s10 that connect two temporally consecutive points among the points P1 to point P11 representing the movement loci 2000 of the agricultural machine M, the lengths of the segments s3 to s7 are less than or equal to the threshold τ.

In this case, from among the sequence of position data that represent the movement loci 2000 of the agricultural machine M, for example, the position data that represent the points P4 to P7 are deleted. As a result, the position data that represent the points P4 to P7 for which it can be determined that the agricultural machine M has stopped consequent to failure of the agricultural machine M or a break taken by the worker, etc., can be deleted from among the sequence of position data that represent the movement loci 2000 of the agricultural machine M.

FIG. 21 is a diagram depicting an example of deletion of position data representing points outside the region of a given field. In FIG. 21, the points P1 to point P29 representing movement loci 2100 through which the agricultural machine M moves are indicated. Further, vertices Q1 to Q4 representing the region of a given field are indicated. In the example depicted in FIG. 21, among the points P1 to point P29 representing the movement loci 2100 of the agricultural machine M, the points P6 to P8, P19 to P21 are outside the region of the given field.

In this case, the position data representing the points P6 to P8, P19 to P21 are deleted from among the sequence of position data representing the movement loci 2100 of the agricultural machine M. As a result, the position data representing points outside the region of the given field can be deleted from among the sequence of position data representing the movement loci 2100 of the agricultural machine M.

An example of separating the position data D1 to Dn will be described with reference to FIGS. 22 and 23. FIG. 22 is a diagram depicting an example of a separation point of a sequence of position data. In FIG. 22, the position data D1 to D49 representing the movement loci of the agricultural machine M are indicated. In the figure, a portion of the position data D1 to D49 is not depicted.

Here, among ranges of a constant width, the range having the greatest rate of travel angles of the agricultural machine M belonging thereto is indicated as the “range Max” and the range Max is assumed to be “85 degrees or more and 95 degrees or less”. In the example depicted in FIG. 22, for each time Ti at which the position data Di is measured, the rates of travel angles belonging to the range Max, among the travel angles of the agricultural machine M based on the 10 position data measured before time Ti, are indicated.

In this case, the separating unit 1902 determines from among the times T1 to Tn, the time Td at which the position data D1 to D49 are to be separated, based on the rate of travel angles belonging to the range Max for each time Ti. Here, the separating unit 1902 assumes, as the time Td, the time where among the five successive times, the percentage of times at which the rate of travel angles belonging to the range Max decreases from that of the immediate previous time, exceeds 50[%].

In the example depicted in FIG. 22, among the 5 consecutive times, times T39 to T43, the percentage of times at which the rate of travel angles belonging to the range Max decreases from than of the immediately previous time exceeds 50[%]. Therefore, the separating unit 1902 determines from among times T1 to T49, the time Td at which the position data D1 to D49 are to be separated, to be “Td=T39”. Based on the determined time Td, the separating unit 1902 separates the position data D1 to D49 into the position data D1 to D38 and the position data D39 to D49.

FIG. 23 is a diagram depicting an example of separating a sequence of position data. In FIG. 23, the points P1 to P49 indicated by the position data D1 to D49 depicted in FIG. 22, are depicted in an orthogonal coordinate system formed by an x axis and a y axis. In the figure, among the points P1 to P49, the points P1, P38, P39, and P49 are indicated by reference numerals.

As described, the time Td at which the position data D1 to D49 are to be separated is “Td=T39”. Therefore, the position data D1 to D49 is separated into the position data D1 to D38 and the position data D39 to D49. As a result, for example, the position data D39 to D49 representing the movement loci of the agricultural machine M moving through the dead space of the given field can be separated from among the position data D1 to D49 representing the movement loci of the agricultural machine M.

FIG. 24 is a diagram depicting an example of deletion of position data that represent an overlapping portion among the movement loci of the agricultural machine M. In FIG. 24, the points P1 to P28 representing first movement loci of the agricultural machine M and the points P29 to P41 representing second movement loci of the agricultural machine M are depicted. (left side of FIG. 24).

The points P1 to P28 representing the first movement loci and the points P29 to P41 representing the second movement loci represent the first position data group and the second position data group separated from sequence of position data representing the movement loci of the agricultural machine M, by the separating unit 1902. The points P1 to P28 representing the first movement loci are loci measured before the points P29 to P41 representing the second movement loci.

An example of a procedure of a process when position data representing an overlapping portion is deleted from among the movement loci of the agricultural machine M will be described.

(24-1) The deleting unit 1901, for example, from among the segments connecting two consecutive points among the points P1 to P28 representing the first movement loci, identifies a segment intersecting any of the segments connecting consecutive points among the points P29 to P41 representing the second movement loci. In the example depicted in FIG. 24, from among the segments connecting two consecutive points among the points P1 to P28, segments s1 to s8 are identified.

(24-2) The deleting unit 1901 identifies from among the segments s1 to s8, the segment to first intersect a segment connecting two consecutive points among the points P29 to P41. In the example depicted in FIG. 24, among the segments s1 to s8, the segment s1 is identified.

(24-3) The deleting unit 1901 identifies a segment that is after the segment s1 and that is the first segment after segments that do not intersect a segment connecting two consecutive points among the points P29 to P41 and that cover a given distance E or more since the intersection of the segment connecting two consecutive points among the points P29 to P41. In the example depicted in FIG. 24, from among the segments s1 to s8, segment s4 is identified.

The given distance E is calculated based on the distance required by the agricultural machine M to change directions and the distance between ridges in dead space, for example. More specifically, for example, the given distance E is “30[m]”. The given distance E is preliminarily set and stored in a storage apparatus such as the ROM 502, the RAM 503, the magnetic disk 505, and the optical disk 507, for example.

(24-4) The deleting unit 1901 deletes from a position data group representing the points P1 to P28, temporally consecutive position data from position data representing the terminal point P5 of the segment s1 to the position data representing the start point P9 of the segment s4. As a result, from among the points P1 to P28 representing the first movement loci, the points P5 to P9 are deleted (right side of FIG. 24).

(24-5) The deleting unit 1901 identifies from among the segments s1 to s8, a segment that is after the segment s4 and that first intersects a segment connecting two consecutive points among the points P29 to P41. In the example depicted in FIG. 24, from among the segments s1 to s8, the segment s5 is identified.

(24-6) The deleting unit 1901 identifies from among the segments s1 to s8, a segment that is after the segment s5 and that is the first segment after segments that do not intersect a segment connecting two consecutive points among the points P29 to P41 and that cover the given distance E or more since the intersection of the segment connecting two consecutive points among the points P29 to P41. In the example depicted in FIG. 24, from among the segments s1 to s8, the segment s8 is identified.

(24-7) The deleting unit 1901 deletes from among the position data group indicating the points P1 to P28, temporally consecutive position data from the position data representing the terminal point P19 of the segment s5 to the position data representing the start point P24 of the segment s8. As a result, from among the points P1 to P28 representing the first movement loci, the points P19 to P24 are deleted (right side of FIG. 24).

Thus, the position data representing an overlapping portion among the movement loci of the agricultural machine M can be deleted from among the sequence of position data representing the movement loci of the agricultural machine M. For example, at (24-6), when segment s8 is identified from among the segments s1 to s8, the deleting unit 1901 may delete from the position data group representing the points P1 to P28, the position data from the position data representing the terminal point P19 of the segment s5 and all of the position data thereafter.

A procedure of a deletion process by the work area calculating apparatus 401 will be described. A procedure of a first deletion process of deleting from the position data D1 to Dn, a position data that represents a point outside a given field will be described. The first deletion process is executed after step S1601 in the first embodiment and depicted in FIG. 16, for example.

FIG. 25 is a flowchart of the first deletion process by the work area calculating apparatus 401. In the flowchart depicted in FIG. 25, the work area calculating apparatus 401 sets “i” of the position data Di to “i=1” (step S2501).

The work area calculating apparatus 401 selects the position data Di from among the position data D1 to Dn (step S2502), and based on position data specifying a region of the given field, determines whether the point indicated by the position data Di is in the region of the given field (step S2503).

If the point indicated by the position data Di is in the region of the given field (step S2503: YES), the work area calculating apparatus 401 proceeds to step S2505. On the other hand, if the point indicated by the position data Di is not in the region of the given field, the work area calculating apparatus 401 deletes the position data Di from among the position data D1 to Dn (step S2504).

The work area calculating apparatus 401 increments “i” of the position data Di (step S2505), and determines whether “i” exceeds “n” (step S2506). If “i” is less than or equal to “n” (step S2506: NO), the work area calculating apparatus 401 returns to step S2502.

On the other hand, if “i” exceeds “n” (step S2506: YES), the work area calculating apparatus 401 reassigns position data IDs for the position data that remain among the position data D1 to Dn (step S2507), and ends a series of operations according to the flowchart.

Thus, the position data that represent points outside the region of the given field can be deleted from the position data D1 to Dn that represent the movement loci of the agricultural machine M.

A procedure of a second deletion process of deleting from among the position data D1 to Dn, position data representing points at which the agricultural machine M has stopped consequent to the failure of the agricultural machine M or a break by the worker. The second deletion process is executed after step S1601 depicted in FIG. 16 of the first embodiment, for example.

FIG. 26 is a flowchart depicting a procedure of a second deletion process by the work area calculating apparatus 401. In the flowchart depicted in FIG. 26, the work area calculating apparatus 401 sets “i” of the position data Di to “i=1” (step S2601).

The work area calculating apparatus 401 increments “i” of the position data Di (step S2602), and determines whether “i” exceeds “n” (step S2603). If “i” is less than or equal to “n” (step S2603: NO), the work area calculating apparatus 401 calculates the length of the segment connecting a point indicated by the position data D(i−1) and a point indicated by the position data Di (step S2604).

The work area calculating apparatus 401 determines if the length of the segment is less than or equal to the threshold τ (step S2605). If the length of the segment exceeds the threshold τ (step S2605: NO), the work area calculating apparatus 401 returns to step S2602. On the other hand, if the length of the segment is less than or equal to the threshold τ (step S2605: YES), the work area calculating apparatus 401 deletes the position data D(i−1) (step S2606), and returns to step S2602.

At step S2603, if “i” exceeds “n” (step S2603: YES), the work area calculating apparatus 401 reassigns position data IDs for the position data that remain among the position data D1 to Dn (step S2607), and ends a series of operations according to the flowchart.

Thus, position data representing points at which the agricultural machine M has stopped consequent to failure of the agricultural machine M or a break taken by the worker can be deleted from among the position data D1 to Dn representing the movement loci of the agricultural machine M.

A procedure of a third deletion process of separating the position data D1 to Dn and deleting position data that represents an overlapping portion will be described. The third deletion process is executed after step S1601 depicted in FIG. 16 of the first embodiment, for example.

FIG. 27 is a flowchart depicting a procedure of a third deletion process by the work area calculating apparatus 401. In the flowchart depicted in FIG. 27, the work area calculating apparatus 401 calculates the travel angles A2 to An of the agricultural machine M (step S2701).

The work area calculating apparatus 40 calculates for each range among ranges of a constant width, a rate of travel angles that belong to the range among the travel angles A2 to An of the agricultural machine M (step S2702). The work area calculating apparatus 401 identifies a range Max that has the greatest rate among the ranges (step S2703).

The work area calculating apparatus 401 calculates at each time Ti when the position data Di is measured, the rate of travel angles belonging to the range Max among the travel angles of the agricultural machine M based on plural position data measured before the time Ti (step S2704). Based on the rate of travel angles belonging to the range having the largest rate at each time Ti, the work area calculating apparatus 401 determines from among times T1 to Tn, a time Td for separating the position data D1 to Dn (step S2705).

Based on the time Td, the work area calculating apparatus 40 separates the position data D1 to Dn into a first position data group and a second position data group (step S2706). The work area calculating apparatus 401 deletes from among the first position data group, position data that represent an overlapping portion in which movement loci among the movement loci of the agricultural machine M represented by the first position data group overlap the movement loci of the agricultural machine M represented by the second position data group (step S2707).

The work area calculating apparatus 401 reassigns position data IDs for the position data remaining among the first position data group and position data IDs for the second position data group (step S2708), and ends a series of operations according to the flowchart.

Thus, position data that represent a portion of overlapping loci among the movement loci of the agricultural machine M can be deleted from among the position data D1 to Dn.

When the third deletion process is executed, the work area calculating apparatus 401 executes the series of operations from step S1602 and thereafter depicted in FIG. 16 of the first embodiment, for the position data remaining in the first position data group and the second position data group, respectively, for example. The work area calculating apparatus 401 may be configured to a combination of the first, the second, and the third deletion processes.

As described, the work area calculating apparatus 401 according to the third embodiment enables position data that represents a first terminal point of a segment that connects two temporally consecutive points among the movement loci of the agricultural machine M and whose length is less than or equal to the threshold τ to be deleted from the position data D1 to Dn.

Thus, position data representing points for which it can be determined that the agricultural machine M has stopped consequent to failure of the agricultural machine M or a break taken by the worker, can be deleted from among the position data D1 to Dn. As a result, portions where the agricultural machine M has stopped consequent to failure of the agricultural machine M or a break taken by the worker are excluded from among the movement loci of the agricultural machine M, enabling improved accuracy of the calculation of the length K of the work interval of the agricultural machine M.

The work area calculating apparatus 401 enables position data representing points outside the region of a given field to be deleted from among the position data D1 to Dn. Thus, portions outside the region of the given field are omitted from among the movement loci of the agricultural machine M, enabling improved accuracy of the calculation of the length K of the work interval of the agricultural machine M.

The work area calculating apparatus 401 enables the rate of travel angles belonging to the range Max, among the travel angles of the agricultural machine M, which is moving along a segment connecting two points represented by temporally consecutive position data among position data measured before time Ti, to be calculated for each time Ti. The work area calculating apparatus 401 enables the position data D1 to Dn to be separated into the first position data group and the second position data group, based on the rate of travel angles belonging to the range Max at each time Ti. Thus, a portion where the agricultural machine M in dead space can be distinguished from among the movement loci of the agricultural machine M and the length K of the work interval of the agricultural machine M can be calculated.

The work area calculating apparatus 401 enables position data representing an overlapping portion of the movement loci of the agricultural machine M represented by the first position data group with the movement loci of the agricultural machine M represented by the second position data group. Thus, an overlapping portion can be excluded from among the movement loci of the agricultural machine M, enabling improved accuracy of the calculation of the length K of the work interval of the agricultural machine M.

The calculation method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the embodiments, the length of a work interval of agricultural work performed by an agricultural machine can be calculated.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A calculation method comprising:
obtaining a temporal sequence of position data representing movement loci of an agricultural machine;
extracting from among the obtained sequence of position data, a set of position data representing an interval among the movement loci of the agricultural machine and in which slopes of segments connecting two points represented by consecutive position data among the sequence of position data are consecutively within a given range; and
calculating based on the extracted set of position data representing the interval, a length of a work interval of agricultural work performed by the agricultural machine, wherein
the calculation method is executed by a computer.

2. A calculation method comprising:
obtaining temporal sequence of position data representing movement loci of an agricultural machine;
extracting from among the obtained sequence of position data, a set of position data representing an interval among the movement loci of the agricultural machine and in which deviations of slopes of segments connecting two points represented by consecutive position data among the sequence of position data are less than or equal to a threshold, for consecutive segments; and
calculating based on the extracted set of position data, a length of a work interval of agricultural work performed by the agricultural machine, wherein
the calculation method is executed by a computer.

3. A calculation method comprising:
obtaining temporal sequence of position data representing movement loci of an agricultural machine;
extracting from among the obtained sequence of position data, a set of position data representing an interval among the movement loci of the agricultural machine and in which a speed of the agricultural machine moving between two points represented by consecutive position data among the sequence of position data is continuously within a given range; and
calculating based on the extracted set of position data, a length of a work interval of agricultural work performed by the agricultural machine, wherein
the calculation method is executed by a computer.

4. The calculation method according to claim 3, wherein
the extracting includes extracting from the sequence of position data, a set of position data representing an interval among the movement loci of the agricultural machine, and in which the speed of the agricultural machine is continuously within the given range and in which deviation of a slope of a segment connecting the two points is less than or equal to a threshold, for consecutive segments, and in which a cumulative length of the consecutive segments is greater than or equal to a given value.

5. The calculation method according to claim 3, wherein
the extracting includes extracting from among the sequence of position data, a set of position data representing an interval among the movement loci of the agricultural machine and in which the speed of the agricultural machine is continuously within the given range, and in which deviation of an angle formed by a reference axis and a travel direction of the agricultural machine moving along a segment connecting the two points is less than or equal to a threshold, for consecutive segments, and in which a cumulative length of the consecutive segments is greater than or equal to a given value.

6. The calculation method according to claim 5, wherein
the travel direction of the agricultural machine is a direction of movement along a segment that connects two points represented by non-consecutive position data among the sequence of position data.

7. The calculation method according to claim 3, wherein
the calculating includes calculating the length of the work interval of agricultural work by cumulating lengths of intervals, based on a set of position data representing the intervals, when the set of position data representing the intervals is extracted.

8. The calculation method according to claim 3 further comprising
calculating a work area of the agricultural work, based on the calculated length of the work interval and an effective width of the agricultural machine.

9. The calculation method according to claim 3 further comprising
deleting from among the sequence of position data, position data that represents a first terminal point among terminal points of a segment that connects two points represented by consecutive position data among the sequence of position data and whose length is less than or equal to a threshold, wherein
the extracting includes extracting from among the sequence of position data from which the position data that represents the first terminal point has been deleted, the set of position data representing the interval.

10. The calculation method according to claim 3 further comprising
calculating an average slope of segments connecting two points represented by consecutive position data among the extracted set of position data representing the interval; and
calculating position data of an intersection of a first line and a second line, where the first line passes through a first terminal point among terminal points of the interval and has a slope that is the average slope, and the second line passes through a second terminal point among the terminal points of the interval and is orthogonal to the first line, wherein
the calculating of the length of the work interval includes calculating the length of the work interval, based on position data of the first terminal point and the position data of the intersection.

11. The calculation method according to claim 3 further comprising:
calculating an average slope of segments connecting two points represented by consecutive position data among position data remaining among the set of position data representing the interval and from which position data of a first terminal point among terminal points of the interval has been excluded; and
deleting from among the set of position data representing the interval, the position data representing the first terminal point, when a difference of the average slope and a slope of a segment connecting two points represented by consecutive position data that are among the set of position data representing the interval and include the position data of the first terminal point is greater than or equal to a threshold, wherein
the calculating of the length of the work interval includes calculating the length of the work interval, based on the set of position data representing the interval and from which the position data representing the first terminal point has been deleted.

12. The calculation method according to claim 3 further comprising
identifying based on slopes of segments connecting two points represented by consecutive position data among position data remaining after excluding position data of a first terminal point among terminal points of the interval from among the set of position data representing the interval, a range among ranges of a constant width and to which slopes of a given rate or greater belong among the slopes of the segments; and
deleting from among the set of position data representing the interval, the position data representing the first terminal point, when the slope of the segment connecting the two points represented by the consecutive position data that includes the position data representing the first terminal point among the set of position data representing the interval is not included in the identified range, wherein
the calculating of the length of the work interval includes calculating the length of the work interval, based on the set of position data representing the interval and from which the position data representing the first terminal point has been deleted.

13. The calculation method according to claim 3 further comprising
deleting from the sequence of position data and based on position data identifying a region of a given field of the agricultural work, position data representing a point outside the region of the given field, wherein
the extracting includes extracting from the sequence of position data from which the position data representing the point outside the given field has been deleted, the set of position data representing the interval.

14. The calculation method according to claim 3 further comprising
calculating for each range among ranges of a constant width, a rate of angles belonging to the range, among angles formed by a reference axis and a travel direction of the agricultural machine moving along a segment connecting two points represented by consecutive position data among the sequence of position data;
identifying among the ranges, a greatest range to which a greatest rate of the angles belong;
calculating for each measurement time of position data among the sequence of position data, the rate of angles belonging to the greatest range, among the angles formed by the reference axis and the travel direction of the agricultural machine moving along a segment connecting two points represented by temporally consecutive position data among position data measured before the measurement time; and
separating based on the calculated rates of the angles belonging to the greatest range for each measurement time, the sequence of position data into a first position data group and a second position data group, in temporal order.

15. The calculation method according to claim 14, further comprising
deleting from among the first position data group, position data representing a portion where movement loci among the movement loci of the agricultural machine represented by the first position data group overlap the movement loci of the agricultural machine represented by the second position data group, wherein
the extracting includes extracting from the first position data group from which the position data representing the portion of overlap has been deleted, the set of position data representing the interval and extracting from the second position data group, the set of position data representing the interval.
